(19) United States
(12) Patent Application Publication
(10) Pub. No.: US 2023/0215052 A1
(43) Pub. Date: Jul. 6, 2023

(54) SYSTEMS AND METHODS FOR INTELLIGENTLY COMPRESSING WHOLE SLIDE IMAGES

(71) Applicants: Kenneth Tang, Irvine, CA (US); Val Anthony Alvero, Irvine, CA (US); Yixiao Zhao, Costa Mesa, CA (US)

(72) Inventors: Kenneth Tang, Irvine, CA (US); Val Anthony Alvero, Irvine, CA (US); Yixiao Zhao, Costa Mesa, CA (US)

(21) Appl. No.: 17/849,474

(22) Filed: Jun. 24, 2022

Related U.S. Application Data
(60) Provisional application No. 63/296,841, filed on Jan. 5, 2022.

(51) Int. Cl. G06T 9/00; G06V 10/26; G06V 20/69; G06T 7/00

(52) U.S. Cl. CPC G06T 9/00; G06V 10/26; G06V 20/695; G06T 7/0012; G06V 2201/03; G06T 2207/20016; G06T 2207/30024

(57) ABSTRACT

Systems and methods for compressing images that include a memory storing an executable code and a processor executing the code to receive a whole slide image, the whole slide image containing a plurality of image layers and metadata associated with each image layer, extract a high-resolution image layer and the corresponding metadata, wherein the high-resolution image layer includes a plurality of image tiles including informative tiles and noninformative tiles, where the informative tiles depict a region of interest of the specimen, analyze the image tiles of the extracted high-resolution image layer, determine a first tile is a noninformative tile, create an informative image layer by removing the first tile from the extracted high-resolution image layer, the informative image layer containing a plurality of informative tiles, compress the informative image layer into a single-layer whole slide image, and save the single-layer whole slide image in the memory.

### BACKGROUND

Presently, digital pathology involves virtual microscopy or whole slide imaging, which entails scanning tissue from glass microscope slides and generating a digital image of the entire slide. Although digital pathology has increased efficiency for pathologists and reduced costs in handling glass microscope slides, shortcomings still exist. In comparison to different types of medical diagnostic images, whole slide image (WSI) file sizes may be 2 to 250 times larger than other types of medical diagnostic image files. For example, an X-ray file size may be 10 megabytes (MB), a magnetic resonance imaging (MM) scan file size may be 100 MB, a computed tomography (CT) scan file size may be 250 MB, and a WSI file size may be 2500 MB, indicating that the WSI file size is exponentially large in comparison to the file sizes of other types of medical diagnostic images. Accordingly, the large WSI files necessitate high storage capacity and network bandwidth, have a high cost of implementation, and lack a centralized digital pathology platform. The high cost of implementation is attributable to storage fees, data management, risk management, and software integration, to name a few. There remains a need to improve upon the current WSI technology in the growing field of digital pathology. The present disclosure provides for a novel system and methods for intelligently compressing whole slide images that addresses the above noted problems and difficulties while retaining the integrity of high-resolution images.

### SUMMARY

The present disclosure provides a novel approach directed to systems and methods for intelligently compressing whole slide images, substantially as shown in and/or described in connection with at least one of the figures, as set forth more completely in the claims.

In some implementations, the system for intelligently compressing whole slide images includes, a non-transitory memory storing an executable code, and a hardware processor executing the executable code to receive a whole slide image depicting a specimen, the whole slide image having an image pyramid containing a plurality of image layers each depicting the specimen with a corresponding layer resolution and a corresponding plurality of metadata associated with each image layer of the plurality of image layers, extract a high-resolution image layer and the corresponding metadata associated with the high-resolution image layer from the image pyramid, wherein the high-resolution image layer includes a plurality of image tiles including informative tiles and noninformative tiles, where the informative tiles depict an image of a region of interest of the specimen, analyze the plurality of image tiles of the extracted high-resolution image layer, determine a first tile of the plurality of image tiles is a noninformative tile, create an informative image layer by removing the first tile from the extracted high-resolution image layer, the informative image layer containing a plurality of informative tiles, and save the single-layer whole slide image in the non-transitory memory.

In some implementations, the hardware processor further executes the executable code to reconstruct a multi-layer image pyramid from the compressed single-layer whole slide image comprising a plurality of reconstructed layers, wherein each reconstructed layer of the plurality of reconstructed layers has a corresponding reconstructed layer resolution.

In some implementations, reconstructing the multi-resolution image pyramid comprises using one of an upsampling algorithm and a downsampling algorithm.

In some implementations, the informative tiles depict a tissue information of the specimen.

In some implementations, each noninformative tile is removed using a tile pixel variance algorithm.

In some implementations, the plurality of noninformative tiles is at least one of a white space around a tissue image and an image of glass borders depicted in an image.

In some implementations, after removing the first tile from the high-resolution image layer, the hardware processor executes the executable code to insert a color value to represent the first tile that was removed.

In some implementations, a file size of the single-layer whole slide image is up to 90% less than a file size of the whole slide image, thereby resulting in a faster retrieval time.

In some implementations, prior to determining the first tile is a noninformative tile, the hardware processor executes the executable code to calculate a probability that the first tile is a noninformative tile, wherein the determination is based on the probability.

In some implementations, the hardware processor executes the executable code to convert the high-resolution image layer from a color image for processing.

In some implementations, prior to saving the single-layer whole slide image in the non-transitory memory, the hardware processor further executes the executable code to compress the informative image layer into a single-layer whole slide image.

In another implementation, a method for intelligently compressing whole slide images includes, wherein the method for use with a computing system having a non-transitory memory and a hardware processor, the method includes receiving, using the hardware processor, a whole slide image depicting a specimen, the whole slide image having an image pyramid containing a plurality of image layers each depicting the specimen with a corresponding layer resolution and a corresponding plurality of metadata associated with each image layer of the plurality of image layers; extracting, using the hardware processor, a high-resolution image layer and the corresponding metadata associated with the high-resolution image layer from the image pyramid, wherein the high-resolution image layer includes a plurality of image tiles including informative tiles and noninformative tiles, where the informative tiles depict an image of a region of interest of the specimen, analyzing, using the hardware processor, the plurality of image tiles of the extracted high-resolution image layer, determining, using the hardware processor, a first tile of the plurality of image tiles is a noninformative tile, creating, using the hardware processor, an informative image layer by removing the first tile from the extracted high-resolution image layer, the informative image layer containing a plurality of informative tiles, and saving, using the hardware processor, the single-layer whole slide image in the non-transitory memory.

In some implementations, the method further includes reconstructing, using the hardware processor, a multi-layer image pyramid from the compressed single-layer whole slide image comprising a plurality of reconstructed layers, wherein each reconstructed layer of the plurality of reconstructed layers has a corresponding reconstructed layer resolution.

In some implementations, the method further includes reconstructing, using the hardware processor, the multi-resolution image pyramid comprises using one of an upsampling algorithm and a downsampling algorithm.

In some implementations of the method, the informative tiles depict a tissue information of the specimen.

In some implementations of the method, each noninformative tile is removed using a tile pixel variance algorithm.

In some implementations of the method, the plurality of noninformative tiles is at least one of a white space around a tissue image and an image of glass borders depicted in an image.

In some implementations of the method, after removing the first tile from the high-resolution image layer, the method further comprises inserting, using the hardware processor, a color value to represent the first tile that was removed.

In some implementations of the method, a file size of the single-layer whole slide image is up to 90% less than a file size of the whole slide image, thereby resulting in a faster retrieval time.

In some implementations of the method, prior to determining the first tile is a noninformative tile, the method further comprises calculating, using the hardware processor, a probability that the first tile is a noninformative tile, wherein the determination is based on the probability.

In some implementations, the method further includes converting the high-resolution image layer from a color image for processing.

In some implementations, prior to saving the single-layer whole slide image in the non-transitory memory, the method further comprises compressing the informative image layer into a single-layer whole slide image.

### BRIEF DESCRIPTION OF THE DRAWINGS

FIG. 1 shows a diagram of an exemplary system for intelligently compressing whole slide images, according to one implementation of the present disclosure;

FIG. 2 shows a side-by-side comparison of a whole slide image using existing technology and a whole slide image using the novel technology of the present disclosure, according to one implementation of the present disclosure;

FIG. 3 shows an exemplary informative tile and an exemplary noninformative tile of the plurality of image tiles in a high-resolution image layer, according to one implementation of the present disclosure;

FIG. 4 shows tiles depicting an exemplary whole slide image and an exemplary labeled whole slide image, according to one implementation of the present disclosure;

FIG. 5 shows a diagram of the technology framework of the system of FIG. 1, according to one implementation of the present disclosure;

FIG. 6 shows a flowchart illustrating an exemplary method of intelligently compressing whole slide images, according to one implementation of the present disclosure; and

FIG. 7 shows a diagram of the difference in whole slide image storage space and whole slide image download time between competitors' technology and the novel technology of the present disclosure, according to one implementation of the present disclosure.

### DETAILED DESCRIPTION

The following description contains specific information pertaining to embodiments and implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale and are not intended to correspond to actual relative dimensions.

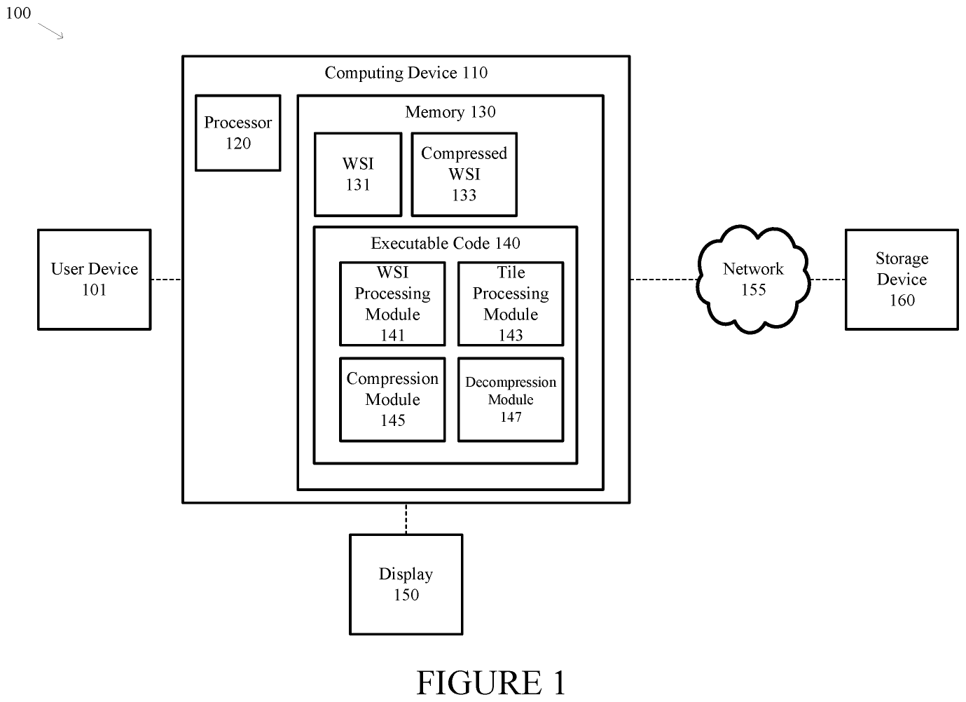

FIG. 1 shows a diagram of an exemplary system for intelligently compressing whole slide images, according to one implementation of the present disclosure. System 100 includes user device 101, computing device 110, display 150, network 155, and storage device 160. User device 101 may be an imaging device, that may be any mechanical, digital, or electronic imaging device. In some implementations, user device 101 may be a microscope-dedicated optical camera. In some implementations, user device 101 may be configured to capture static images for digital imaging, including diagnostic medical imaging technology. In some implementations, user device 101 may be a camera of a smartphone, a scanner, a still camera, a camcorder, or a motion picture camera. In some implementations, user device 101 may be medical imaging equipment. In some implementations, user device 101 may be a whole slide imaging scanner for capturing images depicting the contents of a slide as viewed through a microscope. In some implementations, user device 101 may be a device capable of recording, storing, or transmitting images.

Computing device 110 is a computing system for intelligently compressing whole slide images. In some implementations, computing device 110 may be a computing system for intelligently decompressing a previously intelligently compressed whole slide image. As shown in FIG. 1, computing device 110 includes processor 120 and memory 130. Processor 120 is a hardware processor, such as a central processing unit (CPU) found in computing devices. Memory 130 is a non-transitory storage device for storing computer code for execution by processor 120, and also for storing various data and parameters. As shown in FIG. 1, memory 130 includes whole slide image (WSI) 131, compressed WSI 133, and executable code 140. Executable code 140 is a computer algorithm stored in memory 130 for execution by processor 120 to intelligently compress whole slide images. Further, executable code 140 may intelligently decompress previously intelligently compressed whole slide images. Executable code 140 may include one or more software modules for execution by processor 120. As shown in FIG. 1, executable code 140 includes WSI processing module 141, tile processing module 143, compression module 145, and decompression module 147. In some implementations, executable code 140 may include additional software modules for execution by processor 120.

WSI 131 is a digital image file. In some implementations, WSI 131 may include an image pyramid comprising a plurality of layers each containing the image at a different level of resolution. Each layer of the image pyramid may have metadata associated with it. In some implementations, WSI 131 may be a digital image of a specimen, such as a tissue sample imaged for analysis. WSI 131 may be a digital image of a specimen, such as a tissue sample imaged for diagnosis. The specimen may include a region of interest that includes tissue information related to a condition of the tissue or a condition of the specimen. The plurality of layers may include a high-resolution image, a middle-resolution image, and a low-resolution image. In other implementations, the plurality of layers may include additional layers each depicting the image in a layer resolution. Each layer of WSI 131 may be made up of a plurality of image tiles. Each tile of the plurality of image tiles depicting a portion of the slide. Some image tiles may depict a portion of the specimen. Some image tiles may depict blank slide space. Some image tiles may depict an edge of a slide that is holding the specimen for imaging. An image tile that depicts a portion of the specimen may be considered an informative tile. An image tile that depicts only blank slide space or only an edge of the slide may be considered a noninformative tile.

Compressed WSI 133 is a compressed digital image. Compressed WSI 133 may be a single layer image compressed to preserve space in a computer memory, such as memory 130, and configured to preserve image data for decompression. In some implementations, compressed WSI 133 may be an image including informative tiles that has been compressed. In some implementations, compressed WSI 133 may be an image including informative tiles with substantially all noninformative tiles removed that has been compressed. Compressed WSI 133 may preserve image data to reconstruct an image pyramid comprising a plurality of image layers each having a reconstructed layer resolution, such as a layer including a reconstructed high-resolution image, a layer including a reconstructed middle-resolution image, and a layer including a reconstructed low-resolution image.

WSI processing module 141 is a software module stored in memory 130 for execution by processor 120 to process a whole slide image for intelligent compression, according to one implementation of the present disclosure. In some implementations, WSI processing module 141 may receive a whole slide image having an image pyramid containing a plurality of image layers and a metadata associated with each image layer, wherein each image layer of the image pyramid has an layer resolution. In some implementations, WSI processing module 141 may extract a high-resolution image layer from the plurality of image layers and the metadata associated with the high-resolution image layer, wherein the high-resolution image layer includes a plurality of image tiles depicting an image of a region of interest. In some implementations, WSI processing module 141 may convert the high-resolution image layer from a color image for processing.

Tile processing module 143 is a software module stored in memory 130 for execution by processor 120 to perform analysis of the high-resolution image layer of the WSI, according to one implementation of the present disclosure. In some implementations, tile processing module 143 may analyze the plurality of image tiles of the high-resolution image layer. In some implementations, tile processing module 143 may calculate a probability that a tile in the high-resolution image layer is a noninformative tile. In some implementations, tile processing module 143 may determine that tiles in the high-resolution image layer are noninformative tiles. In some implementations, a first tile may be a noninformative tile. In some implementations, there may be a plurality of noninformative tiles. In some implementations, tile processing module 143 may remove the noninformative tile or the plurality of noninformative tiles from the high-resolution image layer, thereby creating an informative image layer containing a plurality of informative tiles. In some implementations, tile processing module 143 may insert a color value to replace the image data that is removed when the noninformative tiles are removed.

Compression module 145 is a software module stored in memory 130 for execution by processor 120 to intelligently compress a processed high-resolution image layer. In some implementations, compression module 145 may intelligently compress the informative image layer containing the plurality of informative tiles into a single-layer whole slide image. In some implementations, compression module 145 may save the single-layer whole slide image in the non-transitory memory.

Decompression module 147 is a software module stored in memory 130 for execution by processor 120 to intelligently decompress the single-layer whole slide image. In some implementations, decompression module 147 may reconstruct a multi-resolution image pyramid from the intelligently compressed single-layer whole slide image.

Display 150 may include a display suitable for displaying images. In some implementations, display 150 may include a television, a computer monitor, a display of a tablet computer, or a display of a mobile phone. Display 150 may be a light emitting diode (LED) display, an organic light emitting diode (OLED) display, a liquid crystal display (LCD), a plasma display, a cathode ray tube (CRT), an electroluminescent display (ELD), or other display appropriate for viewing images. As depicted in FIG. 1, display 150 is connected to computing device 110. In some implementations, the connection between display 150 and computing device 110 is wired. In some implementations, the connection between display 150 and computing device 110 is wireless. In some embodiments, display 150 may be a television display, a computer display, a mobile telephone display, a tablet computer display, or other technology capable of displaying or conveying images and/or video.

Network 155 is a computer network, such as the Internet, a local area network (LAN), a wireless local area network (WLAN), a wide area network (WAN), a metropolitan area network (MAN), a server area network (SAN), etc.

Storage device 160 is a computing device for storing code for execution by processor 120, and also for storing various data and parameters. Storage device 160 may be a server or other computer storage device. Storage device 160 may be a local storage device or a remote storage device. As depicted in FIG. 1, storage device 160 is connected to computing device 110 via network 155. In some implementations, the connection between storage device 160 and network 155 may be a wired connection. In some implementations, the connection between storage device 160 and network 155 may be a wireless connection. In some implementations, storage device 160 may be directly connected to computing device 110. In some implementations, the connection between storage device 160 and computing device 110 may be a wired connection. In some implementations, the connection between storage device 160 and computing device 110 may be a wireless connection. Storage device 160 may be a data storage server or a cloud storage server. Storage device 160 may be a data storage device used in computer systems or used in connection with computer systems.

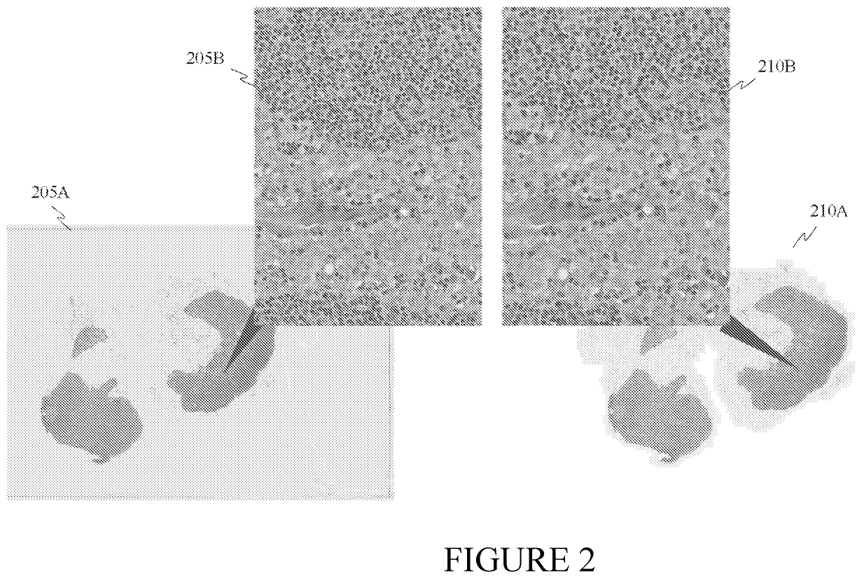

FIG. 2 shows a side-by-side comparison of whole slide image using existing technology 205A and whole slide image using the novel technology of the present disclosure 210A, according to one implementation of the present disclosure. As shown in FIG. 2, magnified image of existing technology 205B depicts a particular area of whole slide image using existing technology 205A at approximately 80× magnification. The file size of the depicted whole slide image using existing technology 205A is 1064 MB. As depicted, whole slide image using existing technology 205A includes the irrelevant white space around a tissue sample image and the image of the irrelevant glass borders of the glass slide. In comparison, the file size of whole slide image using the novel technology of the present disclosure 210A is only 150 MB. In the depicted whole slide image using the novel technology of the present disclosure 210A, substantial amounts of extraneous white space surrounding a tissue sample image and/or the image of the glass borders of the glass slide has been removed. As shown in FIG. 2, magnified image of novel technology of the present disclosure 210B depicts a particular area of whole slide image using novel technology of the present disclosure 210A at approximately 80× magnification.

As shown in FIG. 2, in viewing side-by-side magnified image of existing technology 205B and magnified image of novel technology of the present disclosure 210B from their respective whole slide images 205A, 210A, the integrity of the magnified images 205B, 210B is nearly identical, despite the drastically different data file sizes. In the depicted implementation, the file size of whole slide image using the novel technology of the present disclosure 210A is roughly one-tenth of the file size of the whole slide image using existing technology 205A. As shown, whole slide image using existing technology 205A includes extraneous white space around the tissue that occupies significant data storage, and additional information such as the glass borders of the glass slide are stored as well. In contrast, in some implementations, whole slide image using the novel technology of the present disclosure 210A stores only relevant tissue information and may optionally replace the data corresponding to extraneous white space and/or glass borders of the glass slide by inserting a color value. In some implementations, the color value inserted may be the color value for white. In some implementations, the color value inserted may be for a color other than white.

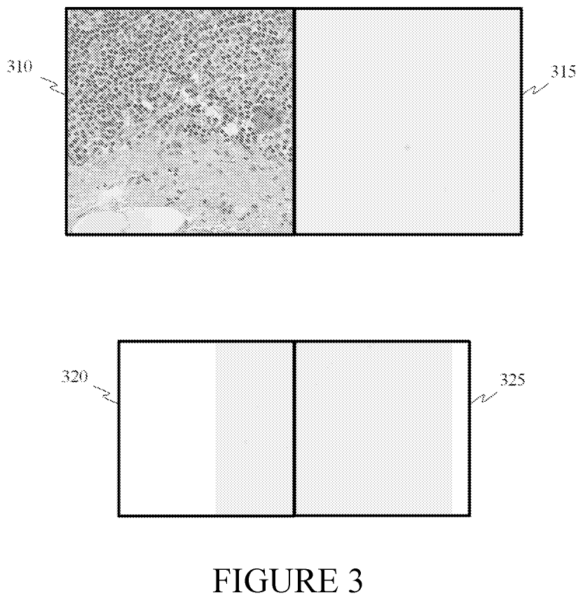

FIG. 3 shows exemplary informative tile 310 and exemplary noninformative tile 315 of the plurality of image tiles in a high-resolution image layer, according to one implementation of the present disclosure. Informative tile 310 may depict informative tissue information for diagnostic pathology purposes. In some implementations, informative tile 310 may depict histologic details of cells, tissues, organs, or other materials. As shown in FIG. 3, noninformative tile 315 includes extraneous information that is not necessary for diagnostic pathology purposes. In some implementations, noninformative tile 315 has images of white space surrounding the region of interest with the tissue information, images of the glass border of the glass slide, and the like. In some implementations, also depicted in FIG. 3, are images of tiles 320, 325 with “stripe” or “band” artifacts. Analysis of such tiles 320, 325 and probability calculations may be included in determining a tile is a noninformative tile or an informative tile.

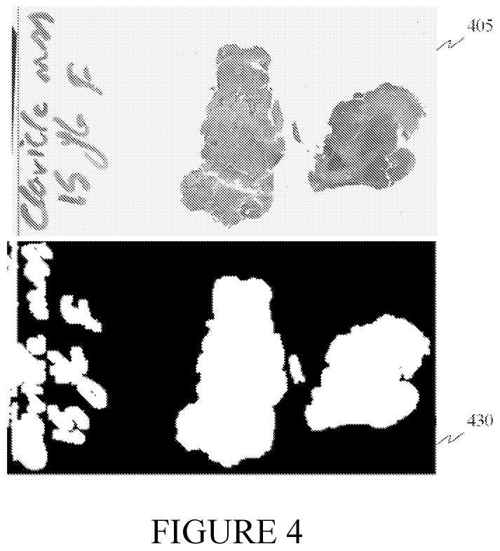

FIG. 4 shows an exemplary whole slide image 405 and labeled whole slide image tiles 430, according to one implementation of the present disclosure. As shown in FIG. 4, whole slide image 405 depicts histologic details of cells, tissues, organ, or other materials, as well as extraneous information, such as white space surrounding the region of interest, and the border of the slide. In some implementations, through analysis of the plurality of image tiles, calculating probability that a tile is a noninformative tile, determine a tile is a noninformative tile, and subsequently label a tile as a noninformative tile. As depicted in FIG. 4, labeled whole slide image tiles 430 shows the area that is shaded black have been labeled as noninformative tiles, according to one implementation of the present disclosure. As depicted, the white area of labeled whole slide image tiles 430 have been labeled as an area of informative tiles, according to an implementation of the present disclosure.

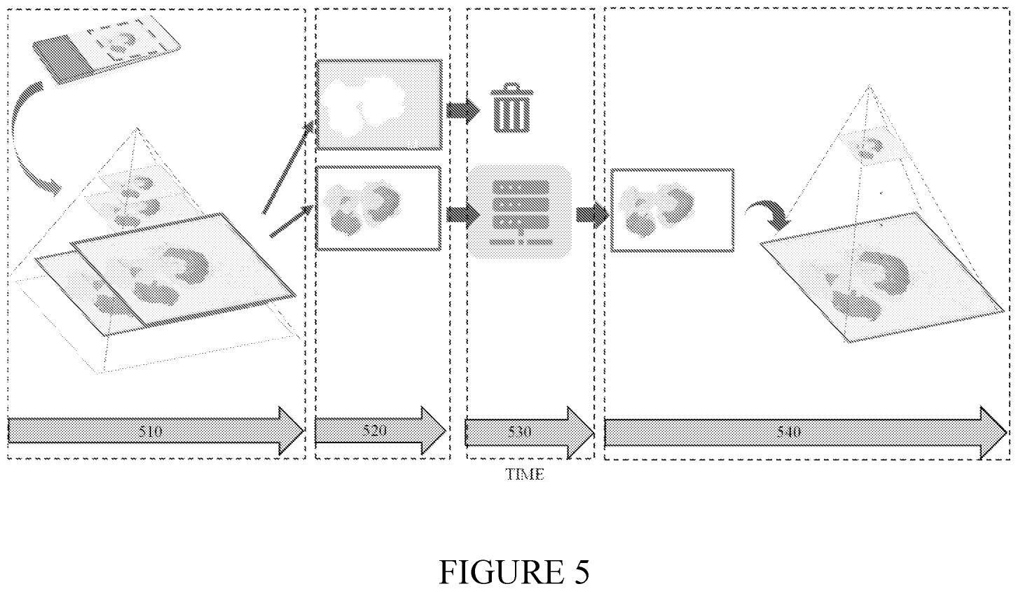

FIG. 5 shows a diagram of the technology framework of the system of FIG. 1, according to one implementation of the present disclosure. In the depicted implementation at 510, an image of a glass slide containing a tissue sample is captured, resulting in a whole slide image that is stored in a computer memory. In some implementations, the tissue sample on the glass slide is stained. In some implementations, the tissue sample on the glass slide is not stained. In some implementations, the whole slide image contains an image of histologic details of cells, tissues, organs, or other materials on a glass slide. In some implementations, the whole slide image has an image pyramid that is composed of multi-resolution image layers along with the associated metadata associated with each image layer. Each image layer has its respective magnification for viewing the image at different levels of detail. Each image layer has a respective layer resolution. Currently, with the existing technology, the general practice is to store the entire image pyramid, which has an enormous file size (e.g., greater than 2 GB), thereby requiring high storage space as well as lengthy waiting time to download images.

As depicted at 510, the novel system of the present disclosure may extract a high-resolution image layer of the from the multi-resolution image layers. In the depicted implementation, the extracted image layer is a high-resolution image layer with informative tissue information for diagnostic pathology purposes. The high-resolution image layer includes a plurality of image tiles, wherein each of the plurality of image tiles is one of an informative tile and a noninformative tile.

At 520, analysis of the plurality of image tiles of the high-resolution image layer may be performed. The plurality of image tiles depict an image of a region of interest, wherein the region of interest depicts the tissue sample having tissue information for diagnostic pathology purposes. An informative tile has relevant tissue information. A noninformative tile has extraneous information, unnecessary for the purposes of diagnostic pathology purposes. In some implementations, the noninformative tiles are images of white space surrounding the region of interest with the tissue information. In some implementations, the noninformative tiles are images of the glass border of the glass slide. As depicted at 520, the presently disclosed novel system may intelligently identify and remove any noninformative tiles using tile pixel variance algorithms. In the depicted implementation at 530, the removed, noninformative tiles are disposed of. In some implementations, the novel system contemplates inserting a color value to represent the noninformative tile that was removed. In some implementations, the color value is white. In some implementations, the color value is a color other than white.

Also depicted at 530, with the removal of any noninformative tiles, what remains of the high-resolution image layer may be created into an informative image layer containing a plurality of informative tiles having informative tissue information, according to one implementation of the present disclosure. In some implementations, the informative image layer includes the plurality of informative tiles. In some implementations, the informative image layer includes the plurality of informative tiles as well as tiles having the inserted color value that replaced the removed, noninformative tiles. The informative image layer is intelligently compressed into a single-layer whole slide image. Further, as depicted at 530, the single-layer whole slide image is saved. In other words, relevant information, such as the informative tiles are stored. In some implementations, the relevant information may be stored in a storage device. Accordingly, the single-layer whole slide image containing only relevant information is stored, which results in up to 90% in reduced file size.

At 540, in some implementations, an image pyramid may be reconstructed using the single-layer whole slide image that was saved. In some implementations, upsampling algorithms are used to generate higher resolution layers. In some implementations, downsampling algorithms are used to generate lower resolution layers. As a result, in the depicted implementation at 540, a full image pyramid is reconstructed for an optimalviewing experience without compromising the integrity of the images.

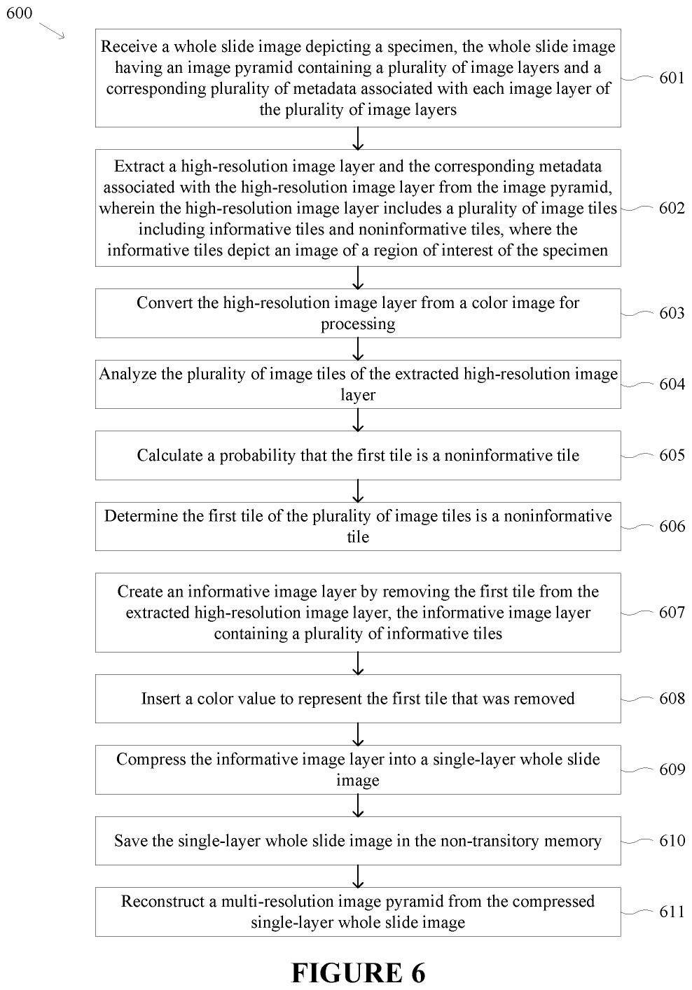

FIG. 6 shows a flowchart illustrating an exemplary method of intelligently compressing whole slide images, according to one implementation of the present disclosure. Flowchart 600 begins at 601 where system 100, using processor 120, receives a whole slide image depicting a specimen, the whole slide image having an image pyramid containing a plurality of image layers each depicting the specimen with a corresponding layer resolution and a corresponding plurality of metadata associated with each image layer of the plurality of image layers. In some implementations, the whole slide image contains an image of the histologic details of cells, tissues, organs, or other materials on a glass slide. The pathology specimen on the glass slide contains specimen information, which may inform various applications in diagnostic pathology, digital management, medical research, medical training, and more. Specimen information depicts characteristics of a specimen for pathologists to examine and interpret findings to make a diagnosis. The tissue sample may be stained with a dye or a chemical to inform the pathologist examining the specimen.

Generally, an image pyramid containing the plurality of image layers includes multiple image levels, so that each image layer of the image pyramid has a specific layer resolution. The different layer resolution may depend on the pixel size of the image layer. For instance, a first image layer may be 50 um*50 um, a second image layer may be 100 um*100 um, a third image layer may be 200 um*200 um, a fourth image layer may be 500 um*500 um, a fifth image layer may be 1 mm*1 mm, and so on. In some implementations, the increments of the pixel size for each image layer may be different. In some implementations, the image pyramid may have less than five image layers. In some implementations, the image pyramid may have more than five image layers.

At 602, system 100, using processor 120, extracts a high-resolution image layer and the corresponding metadata associated with the high-resolution image layer from the image pyramid, wherein the high-resolution image layer includes a plurality of image tiles including informative tiles and noninformative tiles, where the informative tiles depict an image of a region of interest (ROI) of the specimen. The ROI may include the cells, tissues, organs, and other materials on a glass slide. In some implementations, the ROI contains a full histological information to be examined by a pathologist. In some implementations, the ROI may include materials on a glass slide. The pathologist examines the specimen ROI image to interpret findings and make a diagnosis. In addition to depicting an image of a ROI with the specimen, the high-resolution image layer may depict additional areas surrounding the tissue sample. The area surrounding the tissue sample image may include empty portions of the slide appearing as white space around the tissue sampleimage and images of glass borders from the glass slide.

At 603, system 100, using processor 120, may optionally convert the high-resolution image layer from a color image for processing. In some implementations, an RGB color image is converted to a YCbCr space image. In some implementations, an RGB color image is converted to a YUV color space image. In some implementations, a color image is converted to a grayscale image. In some implementations, a color image is converted to a color combination appropriate for further processing, according to an implementation of the present disclosure. Table 1 below shows an example of an RGB image converted to a YUV image.

As shown in Table 1, an RGB color image is converted to a YUV space image. In some implementations, all further image processing is based on a grayscale image of the “Luminance” Y channel, instead of the three-channel RGB image. YUV images are an affine transformation of the RGB image. Y channel is a perceived intensity or “Luminance.” U channel and V channel are chrominance components or “color information.”

Further, Table 2 below depicts an implementation of a color matrix. YCbCr is used for digital signal. Cb is the blue difference, and Cr is the red difference.

TABLE 2
$[ \begin{matrix}{Y}^{′} \\ Cb \\ Cr\end{matrix} ] = [ \begin{matrix}0.257 & 0.504 & 0.098 \\ - 0.148 & - 0.291 & 0.439 \\ 0.439 & - 0.368 & - 0.071\end{matrix} ] [ \begin{matrix}R \\ G \\ B\end{matrix} ] + [ \begin{matrix}16 \\ 128 \\ 128\end{matrix} ]$

At 604, system 100, using processor 120, analyzes the plurality of image tiles of the high-resolution image layer. The plurality of image tiles includes at least one informative tile and at least one noninformative tile. An informative tile contains relevant information, which may include the region of interest with the specimen image containing histological information. In some implementations, a noninformative tile may contain irrelevant information such as only empty space around a tissue sample image. In some implementations, a noninformative tile contains irrelevant information, which may be an image of the glass or glass border from the glass slide.

In some implementations, analysis may include discrete wavelet transform (DWT) with a first tile downsampled lower band (LL) frequency matrix. In some implementations, the analysis includes LL sub-image variance and mean computation. Further analysis includes row and column differences between the plurality of tiles. In some implementations, the plurality of image tiles are labeled and categorized as an informative tile or a noninformative tile.

Table 3 below shows the use of DWT in the analysis of image tiles.

TABLE 3

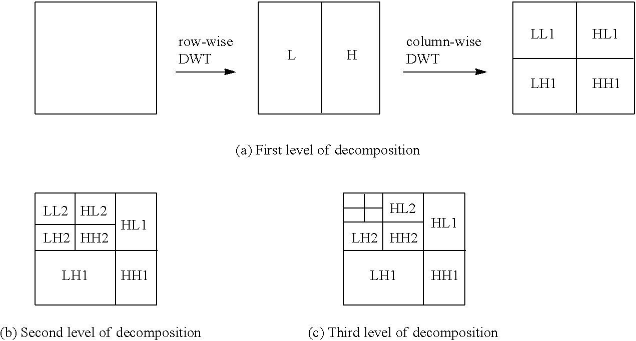

As shown in Table 3, for each image tile, the image is decomposed and downsampled using DWT for four to five levels. Specifically, for each level of decomposition, the low-pass and high-pass filters are used in both row-wise and column-wise directions, wherein the original image can generate four subbands of the image of LL, LH, HL, and HH.

DWT is an algorithm used to reduce dimensionality of an image, feature extraction process. DWT algorithm decomposes the image into four subbands (sub-image) i.e., LL, LH, HL, HH. LL is the approximate image of input image.LL is low frequency sub-band, so it is used for further decomposition process. LH subband extracts the horizontal features of original image. HL subband gives vertical features. HH subband gives diagonal features. For example, if an original size is 512*512, the first LL level frequency band matrix becomes 256*256, second LL matrix is 128*128, and so on.

In some implementations, further analysis may include single tile image analysis. In some implementations, the mean, variance, row, and column differences are calculated on the basis of the LL image with size 32*32. As such, this can used to save computational complexity.

At 605, system 100, using processor 120, may optionally calculate a probability that the first tile is a noninformative tile. Various factors are analyzed, including the pixels associated with the tile, colors, and spectra of light, to name a few. Based on the analysis, the probability of whether a tile is noninformative may be determined. In some implementations, if the probability is above a certain threshold value, then the first tile is noninformative.

At 606, system 100, using processor 120, determines a first tile of the plurality of image tiles is a noninformative tile. In some implementations, the noninformative tile has irrelevant information or is largely blank, whereas the informative tile generally has the tissue information necessary for diagnostic pathology, research, and the like.

In some implementations, each image tile is labeled as one of an informative tile and a noninformative tile. For noninformative tiles, the image variances are usually very low, and the mean is relatively high as it mainly consists of “white space,” without contours and sharp intensity changes within the tile. “White” is the greatest intensity value, while “black” is the smallest intensity value of 0. As depicted in FIG. 3, the exemplary noninformative tile 315 lacks contours and sharp intensity changes and is largely “white space.” In contrast, for informative tiles, the image variance is high, indicating the intensity changes within the image. The mean is low where the tissue and cells are shown in darker colors. As depicted in FIG. 3, the exemplary informative tile 310 shows various changes in intensity within the image, as there are various histologic details of cells, tissues, or other materials in the image.

In some implementations, the row and column differences are used to check on the uniformity of the images. Some tiles have “stripe” or “band” artifacts, wherein the entire row or column have similar patterns. For example, as depicted in the FIG. 3, tiles 320, 325 have “stripe” or “band” artifacts. By calculating the average difference between the nearby pixels with a certain interval along the horizontal and/or vertical directions, these images may be removed as well. As a result, in some implementations, a potential informative tile is labeled as “1,” and a potential noninformative tile is labeled as “0.”

At 607, system 100, using processor 120, removes the first tile from the high-resolution image layer, thereby creating an informative image layer containing a plurality of informative tiles. In some implementations, each noninformative tile is removed using a tile pixel variance algorithm.

In some implementations, a binary image is formed based on the tile labeling information and its location. The contour of the image is drawn, and the isolated and absurd islands or noninformative tiles are removed. Then, the tiles labeled as “1” are dilated for one more pixel to ensure all the edge tiles. FIG. 4 shows an exemplary whole slide image 405 and labeled whole slide image tiles 430. In some implementations as depicted in FIG. 4, labeled whole slide image tiles 430 have been labeled as “0” for noninformative tiles, which may be removed from the high-resolution image layer.

At 608, system 100, using processor 120, may insert a color value to represent the first tile that was removed. In some implementations, the color value for white is inserted, thereby replacing the removed noninformative tile that contained irrelevant information. Removing the noninformative tile and inserting the color value for white in its place ultimately decreases the ending file size. In some implementations, the color value other than white may be inserted. In some implementations, a color value is not inserted. In some implementations, a removed tile is left without information.

At 609, system 100, using processor 120, intelligently compresses the informative image layer containing the plurality of informative tiles into a single-layer whole slide image. As a result, the relevant information in the informative tiles is maintained and stored in high resolution. In some implementations, the system may select intelligent compression techniques and/or intelligent compression parameters based on one or more intelligent compression rules, which may be associated with image characteristics, patient characteristics, and medical history, to name a few.

In some implementations, compression module 145 may write the image tiles. In some implementations, for the informative tiles labeled as “1,” compression module 145 may write the information of the informative tiles to form a single-layer image. In some implementations, where the noninformative tiles are labeled as “0,” the write is disabled and left as a blank tile.

At 610, system 100, using processor 120, may save the single-layer whole slide image in the non-transitory memory. Consequently, large file sizes in gigabytes (GB) can be intelligently compressed in a timely manner and stored without comprising the integrity of the high-resolutionimage quality. A file size of the single-layer whole slide image is up to 90% less than a file size of the whole slide image, thereby resulting in faster retrieval time and requiring less storage capacity and network bandwidth. In some implementations, the file size of the single-layer wholeslide image is 10% to 90% less than the file size of the whole slide image. In some implementations, the file size of the single-layer whole slide image is any increment between 10% to 90% less than the file size of the whole slide image.

At 611, system 100, using processor 120, may reconstruct a multi-resolution image pyramid from the intelligently compressed single-layer whole slide image. In some implementations, reconstructing the multi-resolution image pyramid uses an upsampling algorithm to generate higher resolution layers. In some implementations, reconstructing the multi-resolution image pyramid uses a downsampling algorithm to generate lower resolution layers. By reconstructing a multi-resolution image pyramid, pathologists and other professionals still have the high-standard viewing experience that they are accustomed to.

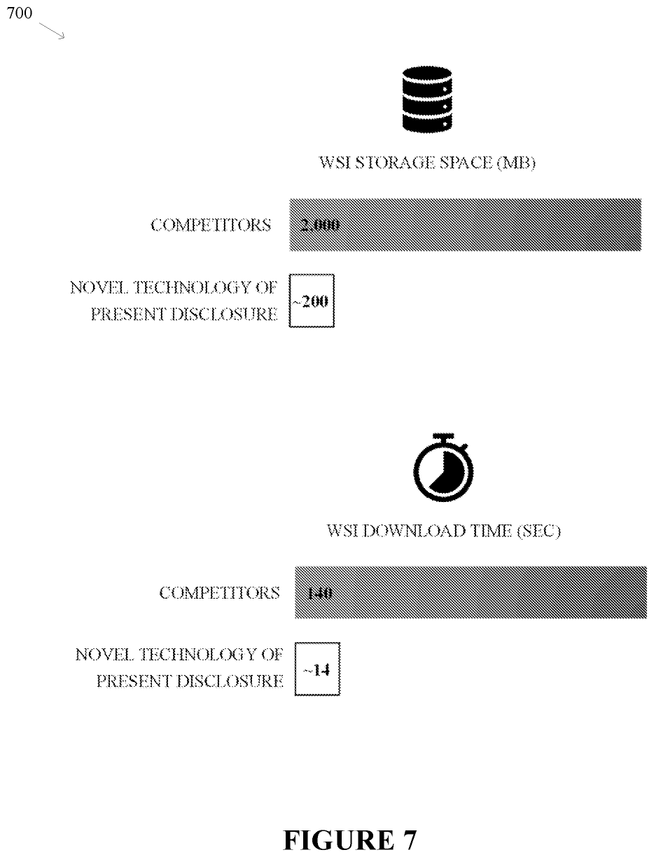

FIG. 7 shows a diagram of the difference in whole slide image storage space and whole slide image download time between competitors' technology and the novel technology of the present disclosure, according to one implementation of the present disclosure. Current practices for storing whole slide images using existing technology involve storing an entire whole slide image pyramid. In contrast, the novel technology of the present disclosure intelligently removes irrelevant information and utilizes an intelligent compression approach to store only relevant information in a single-layer whole slide image that is a high-resolution image layer. Accordingly, the novel system and methods of the present disclosure result in significant reduction in costs, storage, bandwidth, and more.

As shown in FIG. 7 on the left, the novel technology of the present disclosure contemplates requiring ten times less storage space for whole slide images compared to competitors. For example, as depicted, a whole slide image of competitors' existing technology has an average file size of 2 GB, thus requiring 2,000 MB in storage space. In contrast, a whole slide image using the novel technology of the present disclosure requires around 200 MB storage space.

As shown on the right side of FIG. 7, the novel technology of the present disclosure contemplates requiring ten times less download time for whole slide images compared to competitors' existing technology. For example, as depicted, based on a network bandwidth of 1 gigabit per second (Gbit/s), competitors' existing technology would require around 140 seconds to download a 2 GB whole slide image. In contrast, a whole slide image using the novel technology of the present disclosure would only require around 14 seconds.

In some implementations, the present disclosure contemplates lower bandwidth demands for whole slide image retrieval, thereby enabling quicker access to whole slide images.

In some implementations, also contemplated is the reduced processing time for artificial intelligence (AI) analysis. In some implementations, the present disclosure contemplates incorporating machine learning, thereby reducing processing time, including time required for analysis of image tiles.

In some implementations, intelligent compression of WSIs may reduce cost of data storage and management implementation.

In some implementations, the present disclosure also contemplates enabling the development of an intelligent data management system for real world pathology data.

The present disclosure contemplates implementations of automatically selecting an appropriate intelligent compression technique and intelligent compression parameters for whole slide images (WSI) in order to reduce or prevent loss of significant information that does not impact the usefulness or diagnosis of the digital pathology images. Based on various image characteristics associated with a WSI, the present disclosure contemplates dynamically and intelligently compressing whole slide images using particular intelligent compression techniquesand by adjusting intelligent compression parameters, to maintain diagnostic tissue information ofthe image. The system may select intelligent compression techniques and/or intelligent compression parameters based on one or more intelligent compression rules, which may be associated with image characteristics, patient characteristics, medical history, etc. Further, the system may, based on the one or more intelligent compression rules, intelligently compress the image to a maximum degree of intelligent compression while maintaining the significant information of the image.

From the above description, it is manifest that various techniques can be used for implementing the concepts described in the present application without departing from the scope of those concepts. Moreover, while the concepts have been described with specific reference to certain implementations, a person having ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A system comprising:
a non-transitory memory storing an executable code; and
a hardware processor executing the executable code to:
receive a whole slide image depicting a specimen, the whole slide image having an image pyramid containing a plurality of image layers each depicting the specimen with a corresponding layer resolution and a corresponding plurality of metadata associated with each image layer of the plurality of image layers;
extract a high-resolution image layer and the corresponding metadata associated with the high-resolution image layer from the image pyramid, wherein the high-resolution image layer includes a plurality of image tiles including informative tiles and noninformative tiles, where the informative tiles depict an image of a region of interest of the specimen;
analyze the plurality of image tiles of the extracted high-resolution image layer;
determine a first tile of the plurality of image tiles is a noninformative tile;
create an informative image layer by removing the first tile from the extracted high-resolution image layer, the informative image layer containing a plurality of informative tiles; and
save the single-layer whole slide image in the non-transitory memory.

2. The system of claim 1, wherein the hardware processor further executes the executable code to reconstruct a multi-layer image pyramid from the compressed single-layer whole slide image comprising a plurality of reconstructed layers, wherein each reconstructed layer of the plurality of reconstructed layers has a corresponding reconstructed layer resolution.

3. The system of claim 2, wherein reconstructing the multi-resolution image pyramid comprises using one of an upsampling algorithm and a downsampling algorithm.

4. The system of claim 1, wherein the informative tiles depict a tissue information of the specimen.

5. The system of claim 1, wherein each noninformative tile is removed using a tile pixel variance algorithm.

6. The system of claim 1, wherein the plurality of noninformative tiles is at least one of a white space around a tissue image and an image of glass borders depicted in an image.

7. The system of claim 1, wherein after removing the first tile from the high-resolution image layer, the hardware processor executes the executable code to insert a color value to represent the first tile that was removed.

8. The system of claim 1, wherein a file size of the single-layer whole slide image is up to 90% less than a file size of the whole slide image, thereby resulting in a faster retrieval time.

9. The system of claim 1, wherein, prior to determining the first tile is a noninformative tile, the hardware processor executes the executable code to calculate a probability that the first tile is a noninformative tile, wherein the determination is based on the probability.

10. The system of claim 1, wherein, prior to saving the single-layer whole slide image in the non-transitory memory, the hardware processor further executes the executable code to compress the informative image layer into a single-layer whole slide image.

11. A method for use with a computing system having a non-transitory memory and a hardware processor, the method comprising:
receiving, using the hardware processor, a whole slide image depicting a specimen, the whole slide image having an image pyramid containing a plurality of image layers each depicting the specimen with a corresponding layer resolution and a corresponding plurality of metadata associated with each image layer of the plurality of image layers;
extracting, using the hardware processor, a high-resolution image layer and the corresponding metadata associated with the high-resolution image layer from the image pyramid, wherein the high-resolution image layer includes a plurality of image tiles including informative tiles and noninformative tiles, where the informative tiles depict an image of a region of interest of the specimen;
analyzing, using the hardware processor, the plurality of image tiles of the extracted high-resolution image layer;
determining, using the hardware processor, a first tile of the plurality of image tiles is a noninformative tile;
creating, using the hardware processor, an informative image layer by removing the first tile from the extracted high-resolution image layer, the informative image layer containing a plurality of informative tiles; and
saving, using the hardware processor, the single-layer whole slide image in the non-transitory memory.

12. The method of claim 11, further comprising reconstructing, using the hardware processor, a multi-layer image pyramid from the compressed single-layer whole slide image comprising a plurality of reconstructed layers, wherein each reconstructed layer of the plurality of reconstructed layers has a corresponding reconstructed layer resolution.

13. The method of claim 12, wherein reconstructing, using the hardware processor, the multi-resolution image pyramid comprises using one of an upsampling algorithm and a downsampling algorithm.

14. The method of claim 11, wherein the informative tiles depict a tissue information of the specimen.

15. The method of claim 11, wherein each noninformative tile is removed using a tile pixel variance algorithm.

16. The method of claim 11, wherein the plurality of noninformative tiles is at least one of a white space around a tissue image and an image of glass borders depicted in an image.

17. The method of claim 11, wherein, after removing the first tile from the high-resolution image layer, the method further comprises inserting, using the hardware processor, a color value to represent the first tile that was removed.

18. The method of claim 11, wherein a file size of the single-layer whole slide image is up to 90% less than a file size of the whole slide image, thereby resulting in a faster retrieval time.

19. The method of claim 11, wherein, prior to determining the first tile is a noninformative tile, the method further comprises calculating, using the hardware processor, a probability that the first tile is a noninformative tile, wherein the determination is based on the probability.

20. The method of claim 11, wherein, prior to saving the single-layer whole slide image in the non-transitory memory, the method further comprises compressing the informative image layer into a single-layer whole slide image.
